(19) United States
(12) Patent Application Publication
(10) Pub. No.: US 2012/0206477 A1
(43) Pub. Date: Aug. 16, 2012

(54) INFORMATION RETRIEVAL DEVICE AND INFORMATION RETRIEVAL METHOD

(75) Inventor: Masaaki Yanagisawa, Hamura-shi (JP)

(73) Assignee: CASIO COMPUTER CO., LTD., Tokyo (JP)

(21) Appl. No.: 13/362,191

(22) Filed: Jan. 31, 2012

(30) Foreign Application Priority Data
Feb. 15, 2011 (JP) 2011-029676

(51) Int. Cl. G09G 5/02

(52) U.S. Cl. 345/589

(57) ABSTRACT

An information retrieval device comprises a dictionary storage module which stores an entry word, explanatory information that includes an image corresponding to the entry word, and color information on the image so as to correlate the entry word, the explanatory information, and the color information with one another, a color sample display module, a color specify module which specifies an arbitrary color from the color sample displayed, a color retrieval module which retrieves explanatory information stored in the dictionary storage module so as to be correlated with color information corresponding to a color specified, and a retrieved information output module which outputs explanatory information retrieved.

### CROSS-REFERENCE TO RELATED APPLICATIONS

This application is based upon and claims the benefit of priority from prior Japanese Patent Application No. 2011-029676, filed Feb. 15, 2011, the entire contents of which are incorporated herein by reference.

### BACKGROUND OF THE INVENTION

1. Field of the Invention

Embodiments described herein relate generally to an information retrieval device and an information retrieval method which retrieve and output dictionary information.

2. Description of the Related Art

In recent years, the display screen of an electronic dictionary device has been given color capability. Therefore, dictionary content has, accordingly, been produced in color. Such content as pictorial books that use photographs and pictures as main explanatory information are also included in the dictionary device.

In dictionary data, an entry word and its definition are generally stored in such a manner the former and the latter are made to correspond to each other. An entry word that coincides with a search word input in characters by the user is retrieved. Then, explanatory information corresponding to the retrieved entry word is read and displayed.

When the user wants to retrieve and look at an image by specifying dictionary data, such as a pictorial book, if the user knows the name (entry word) of the image, he or she can enter a search word to search for an entry word, read an image caused to correspond to the entry word as explanatory information, and display the image.

However, even when knowing an image the user wants to see, if the user does not know its name, he or she has no choice but to search for an entry word sequentially or predict an entry word and therefore cannot retrieve the image easily.

A computer-based color specify system which displays a color palette on the screen of a display device to enable the user to specify an arbitrary color has been proposed (for example, Jpn. Pat. Appln. KOKAI Publication No. 2002-074380).

### BRIEF SUMMARY OF THE INVENTION

An object of an embodiment of the invention is to provide an information retrieval device which makes it possible to retrieve dictionary data, such as a pictorial book including images, easily.

An information retrieval device according to an embodiment of the invention comprises a dictionary storage module which stores an entry word, explanatory information that includes an image corresponding to the entry word, and color information on the image so as to correlate the entry word, the explanatory information, and the color information with one another, a color sample display module which display a color sample, a color specify module which specifies an arbitrary color according to a user operation from the color sample displayed by the color sample display module, a color retrieval module which retrieves explanatory information stored in the dictionary storage module so as to be correlated with color information corresponding to a color specified by the color specify module, and a retrieved information output module which outputs explanatory information retrieved by the color retrieval module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an outer configuration of an electronic dictionary device 10 according to an embodiment of an information retrieval device of the invention;

FIG. 2 is a block diagram showing a configuration of the electronic circuitry of the electronic dictionary device 10;

FIG. 3 shows a data structure of a pictorial dictionary 22b4 stored in a dictionary database 22b of the electronic dictionary device 10;

FIG. 4 is a flowchart to explain a pictorial book search process when the pictorial dictionary 22b4 is specified as a dictionary to be searched in the electronic dictionary device 10;

FIG. 5 shows a search word input screen G initially displayed by a main display module 16 as a result of a pictorial book search process in the electronic dictionary device 10;

FIG. 6 shows a compound retrieval input screen Gf of the main display module 16 and a color palette CP of an auxiliary display module 15 which are initially displayed when [Compound retrieval] input method is selected as a result of the pictorial search process in the electronic dictionary device 10;

FIG. 7 shows a concrete example of key words input in keyword input area Ek and colors input in color input area Ec on the compound retrieval input screen Gf of the main display module 16; and

FIG. 8 is a flowchart to explain a compound retrieval process as a result of the pictorial book search process in the electronic dictionary device 10.

### DETAILED DESCRIPTION OF THE INVENTION

Hereinafter, referring to the accompanying drawings, an embodiment of the invention will be explained.

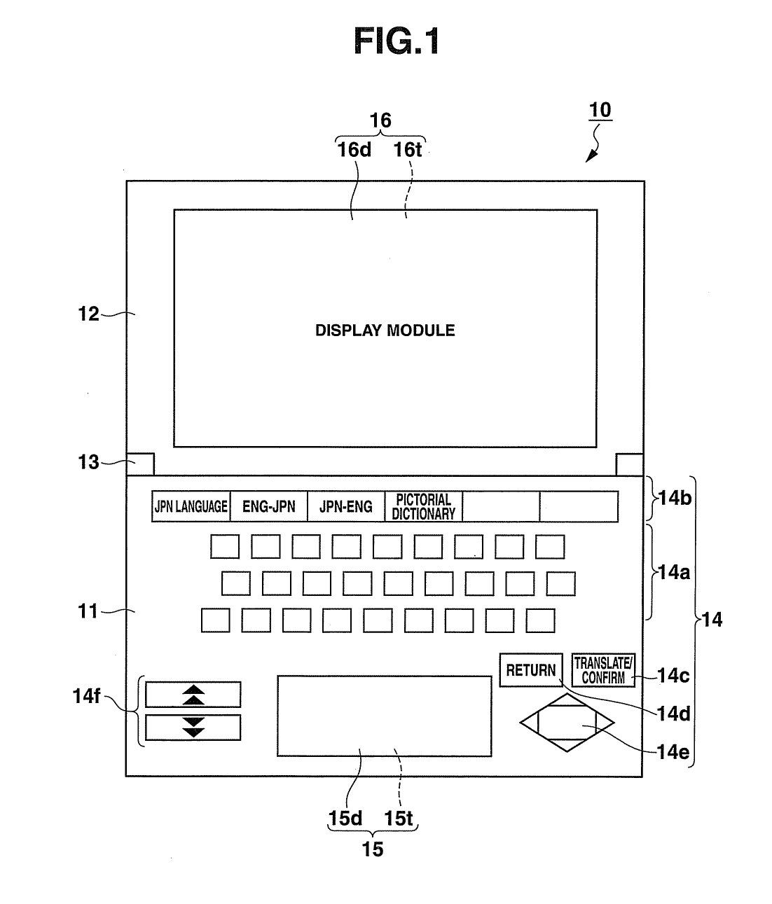

FIG. 1 is a front view showing an outer configuration of an electronic dictionary device 10 according to an embodiment of an information retrieval device of the invention.

The electronic dictionary device 10 is configured as a portable device dedicated to an electronic dictionary explained below or as a personal digital assistant (PDA), a personal computer (PC), a cellular phone, an electronic book reader, a portable video game console, or the like each of which has a dictionary function.

The electronic dictionary device 10 is so configured that a body case 11 and a cover case 12 are coupled with each other via a hinge part 13 so as to form a foldable case that can be opened and closed. At the surface of the body case 11 with the foldable case opened, there are provided a key input module (keyboard) 14 and a handwriting input module (hereinafter, referred to as an auxiliary display module) 15. The key input module 14 comprises character input keys 14a, dictionary specify keys 14b, [Translate/Confirm] key 14c, [Return] key 14d, cursor key 14e, and page feed keys 14f.

The auxiliary display module 15 has a structure where a display device and a touch position detecting device that detects a position touched by the user with a stylus pen, a finger, or the like are integrally formed. The auxiliary display module 15 is so configured that, for example, a transparent touch panel 15t is laid on a 256×64 dot backlight color liquid-crystal display screen 15d on the front side of the central part of the key input module 14. An input area of the auxiliary display module 15 is switched to a handwriting character input area for inputting a handwriting character, a key input area for various functions, an area where these input areas are mixed, or a color palette CP for specifying a color (FIG. 6) as needed.

A trace of handwriting input in the handwriting character input area switched on the auxiliary display module 15 is echoed back to the backlight color liquid-crystal display screen 15d, which displays the trace.

At the surface of the cover case 12, for example, a 480×320 dot touch panel display module (hereinafter, referred to as a main display module) 16 with a backlight is provided on almost all the surface. Like the auxiliary display module 15, the main display module 16 has a structure where a display device and a touch position detecting device that detects a position touched by the user with a stylus pen, a finger, or the like are integrally formed. The main display module 16 is so configured that a transparent touch panel 16t is laid on a backlight color liquid-crystal display screen 16d.

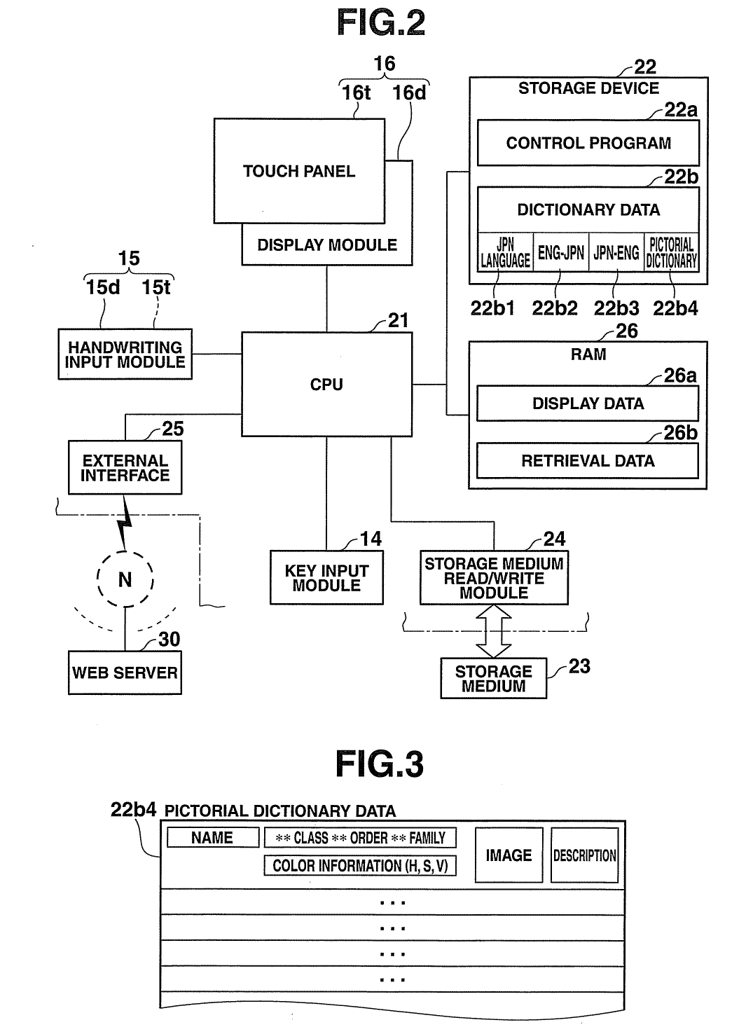

FIG. 2 is a block diagram showing a configuration of the electronic circuitry of the electronic dictionary device 10.

The electronic dictionary device 10 is composed of a computer which reads programs recorded in various storage media and is controlled by the read programs. The electronic circuitry of the device 10 comprises a central processing unit (CPU) 21.

The CPU 21 controls the operation of each of the various parts of the circuitry using a RAM 26 as a work memory according to a device control program 22a prestored in the memory device 22. The device control program 22a may be read into the storage device 22 from an external storage medium 23, such as a ROM card, via a storage medium read/write module 24, or from a Web server (in this case, a program server) 30 on the Internet N via an external interface 25.

The device control program 22a stored in the memory device 22 is activated in response to an input signal corresponding to a user operation from the key input module 14, auxiliary display module 15, or main display module 16.

Connected to the CPU 21 are the memory device 22, storage medium read/write module 24, external interface 25, RAM 26, key input module 14, auxiliary display module 15, and main display module 16.

Stored as the device control programs 22a in the memory device 22 are a system program that supervises the operation of the entire electronic dictionary device 10 and a communication program for performing data communication with each Web server 30 on the Internet N via the external interface 25. Further stored in the storage device 22 is a dictionary search program for controlling an overall search and display process based on the dictionary database 22b. The dictionary search program includes programs which perform the process of inputting and recognizing handwritten characters in a dictionary function, the process of inputting a search word, the process of retrieving an entry word corresponding to a search word, the process of displaying retrieved entry words in list form, the process of reading and displaying various items of explanatory information corresponding to an entry word specified with the cursor, the process of inputting a search color, the process of retrieving a color, the process of reading and displaying a search image, a compound retrieval process corresponding to the search word and search color, and others.

In the dictionary database 22b, not only [Japanese-language dictionary] 22b1, [English-Japanese dictionary] 22b2, and [Japanese-English dictionary] 22b3 but also a plurality of types of dictionary data, including [Pictorial dictionary] 22b4 organized in such a manner that color images, including pictures and photographs, are caused to correspond to their names (entry words), have been previously stored or downloaded and stored.

FIG. 3 shows a data structure of the pictorial dictionary 22b4 stored in the dictionary database 22b of the electronic dictionary device 10.

In the pictorial dictionary 22b4, various things, animals and plants, and personal names (entry words) are stored so as to be caused to correspond to their images (pictures or photographs) and descriptions as explanatory information. In addition, they are further caused to correspond to color information represented in an HSV color space of the images. Each item of explanatory information on a pictorial book about animals and plants includes information indicating its category (**class/**order/**family, or the like).

The HSV color space is composed of three components, hue, chroma, and brightness. The HSV color space is a nonlinear conversion of an RGB color space.

In the RAM 26, a display data memory 26a and a retrieval data memory 26b are secured.

In the display data memory 26a, display data to be displayed by the main display module 16 or auxiliary display module 15 is developed into a bitmap pattern and stored.

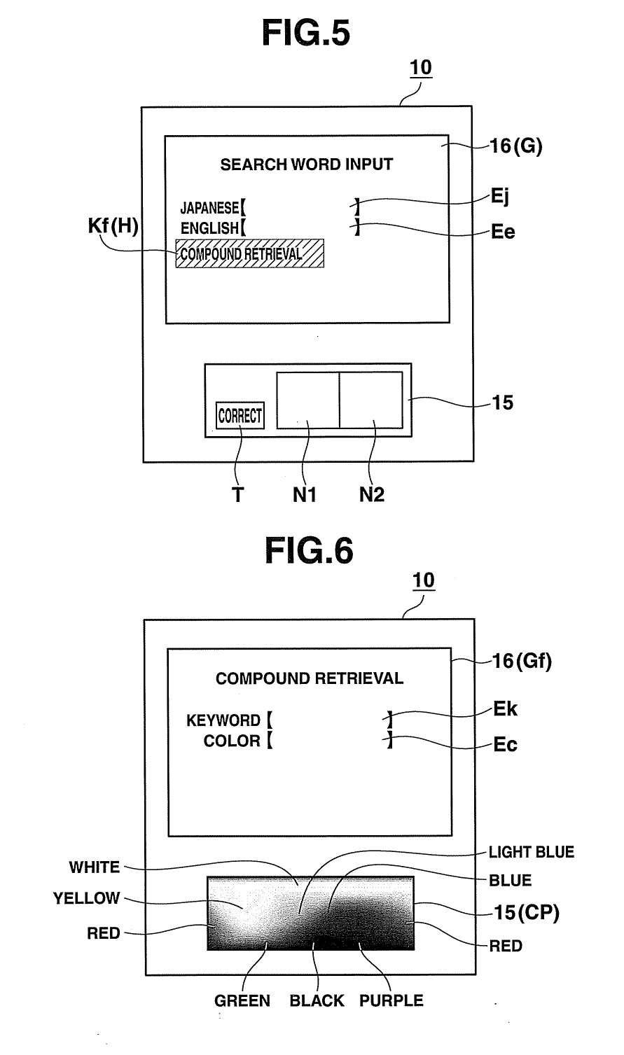

In the retrieval data memory 26b, an entry word or the like retrieved from dictionary data 22b on the basis of a search word or the like input from the search word input screen G (FIG. 5) is stored as retrieval data.

In the electronic dictionary device 10 configured as described above, the CPU 21 controls the operation of each part of the circuit according to instructions written in the device control program 22a so as to cause software and hardware to operate in cooperation with each other, thereby realizing functions described below.

Next, the operation of the electronic dictionary device 10 with the above configuration will be explained.

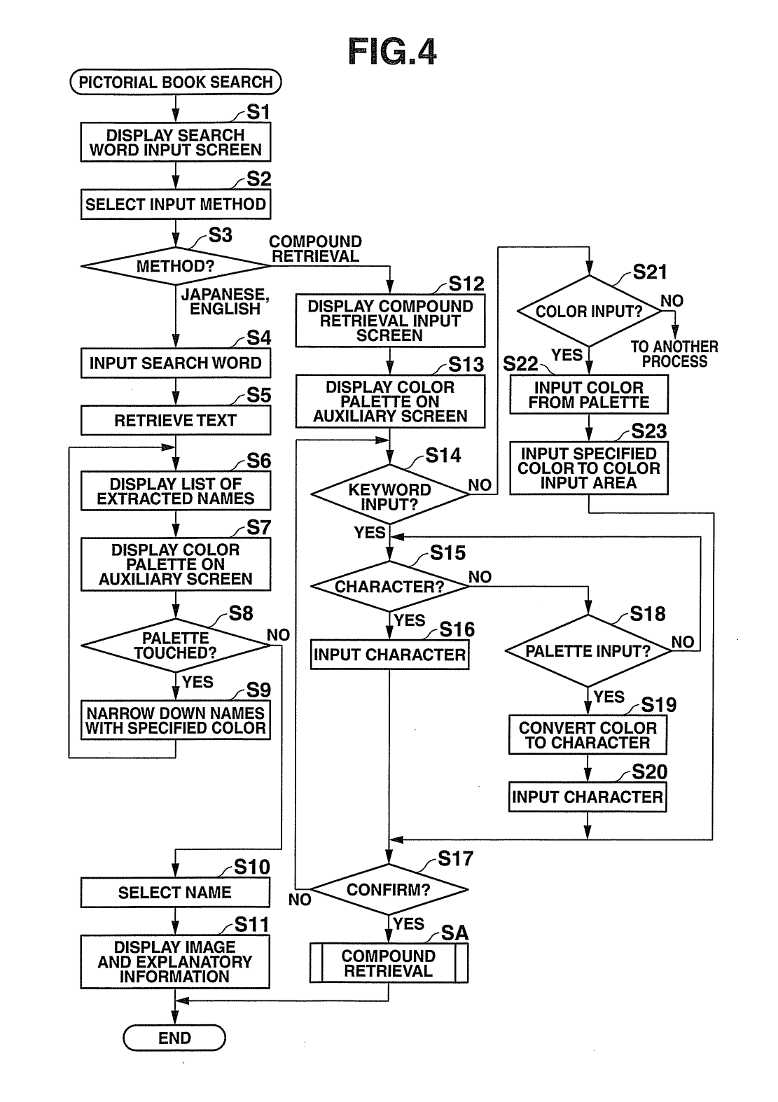

FIG. 4 is a flowchart to explain a pictorial book search process when the pictorial dictionary 22b4 is specified as a dictionary to be searched in the electronic dictionary device 10.

FIG. 5 shows a search word input screen G initially displayed by the main display module 16 as a result of a pictorial book search process in the electronic dictionary device 10.

FIG. 6 shows a compound retrieval input screen Gf displayed by the main display module 16 and a color palette CP displayed by the auxiliary display module 15 when [Compound retrieval] input method is selected in searching a pictorial book in the electronic dictionary device 10.

When the pictorial dictionary 22b4 has been specified according to a user operation on the dictionary specify keys 14b, a pictorial book search process in FIG. 4 is activated and a search word input screen G is displayed by the main display module 16 as shown in FIG. 5 (step S1). On the search word input screen G, items for selecting an input method, [Japanese], [English], and [Compound retrieval], are displayed. [Japanese] and [English] are provided with search character input areas Ej, Ee, respectively.

At this time, on the auxiliary display module 15, handwriting character input areas N1, N2 and [Correct] key T are displayed.

On the search word input screen G, when [Japanese] or [English] has been selected with cursor H as an input method (steps S2, S3 [Japanese, English]), a search word desired by the user is input to the selected search character input area Ej or Ee with the character input keys 14a or by inputting handwritten characters from the auxiliary display 15 (step S4).

When the input characters have been accepted, texts of entry words (names) in the pictorial dictionary 22b4 that coincide in the front part with the input Japanese or English search word are retrieved (step S5). A list of entry words (names) extracted through the retrieval is displayed by the main display module 16 (step S6).

As a result, on the auxiliary display module 15, a color palette CP is displayed as shown in FIG. 6 (step S7). The color palette CP is a color sample that represents shades of multiple colors gradationally. The color palette CP has hues in the horizontal axis direction and changes in the chroma and in the brightness in the vertical axis direction. The color palette may have hues in the horizontal axis direction and changes in the chroma in the vertical axis direction, while brightness may be changed by a specified key operation. Alternatively, an indicator that allows brightness to change in a longitudinal direction may be displayed independently and brightness be specified on the indicator.

Here, when a color the user is going to check has been specified by a touch operation on the color palette CP (Yes in step S8), the RGB value of the specified color is converted into an HSV value. From the displayed list of entry words (names), entry words (names) that have color information corresponding to the converted HSV value are narrowed down (step S9).

Then, a list of the narrowed-down entry words (names) is displayed by the main display module 16 (step S6).

When an entry word (name) desired by the user has been selected from the list of entry words (names) displayed by the main display module 16 (step S10), explanatory information composed of images and descriptions stored in the pictorial dictionary 22b4 so as to correspond to the selected entry word (name) is read and displayed by the main display module 16 (step S11).

As a result, not only are entry words (names) that coincide with a search word desired by the user retrieved and displayed in list form, but also specifying a desired color on the color palette CP causes the displayed list of entry words (names) to be narrowed down to entry words (names) that have color information corresponding to the specified color. The narrowed-down entry words (names) are displayed. Therefore, it is possible to efficiently retrieve an entry word (name) in the pictorial book (22b4) that has a desired image as explanatory information and to display the image easily.

On the other hand, with the search word input screen G of FIG. 5 being displayed (step S1), when choice item Kf of [Compound retrieval] is selected with cursor H as an input method (steps S2, S3 [compound retrieval]), a compound retrieval input screen Gf provided with a keyword input area Ek and a color input area Ec is displayed by the main display module 16 as shown in FIG. 6 (step S12). In addition, on the auxiliary display module 15, a color palette CP is displayed (step S13).

When the compound retrieval input screen Gf has been displayed, it is determined whether there has been an input to the keyword input area Ek. If a keyword input has been accepted (Yes in step S14), it is determined whether the keyword has been input in characters or from the color palette CP (steps S15, S18). If it has been determined that a character has been input (Yes in step S15), the character is input to the keyword area Ek and displayed (step S16).

If it has been determined that the keyword has been input from the color palette CP (Yes in step S18), a color recognized according to the RGB value of the specified position is converted into a character (step S19) and a character representing a color is input to the keyword input area Ek and displayed (step S20).

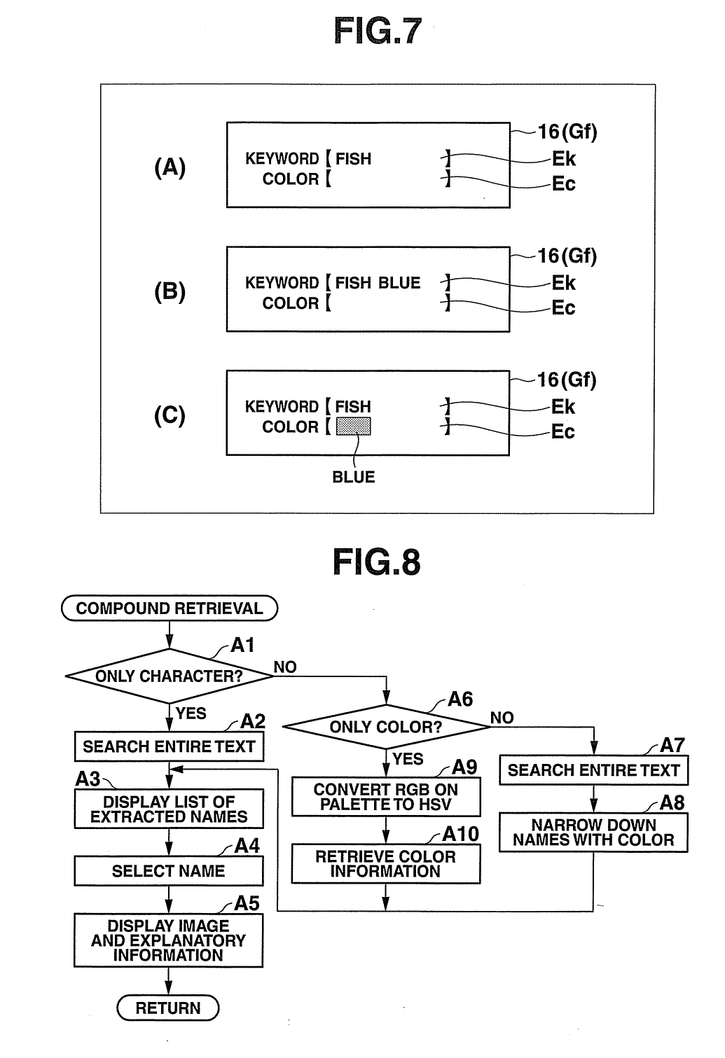

For example, when the character “fish” is input according to the operation of the character input keys 14a (Yes in step S15), the character “fish” is displayed in the keyword area Ek as shown by (A) in FIG. 7 (step S16).

In addition, for example, when the position of blue has been specified according to a touch operation on the color palette CP (Yes in step S18), blue recognized according to the RGB value of the specified position is converted into the character “blue” (step S19). As shown by (B) in FIG. 7, the character “blue” is additionally displayed in the keyword input area Ek (step S20).

Here, when [Translate/Confirm] key 14c is operated after the keyword has been input to the keyword input area Ek (Yes in step S17), control is passed to a compound retrieval process (step SA). FIG. 8 is a flowchart to explain a compound retrieval process.

In the compound retrieval process, if it has been determined that the contents inputted on the compound retrieval input screen Gf are only the character input to the keyword input area Ek (Yes in step A1), the entire text of all the entry words (names) and explanatory information stored in the pictorial dictionary 22b4 (FIG. 3) is searched using the keyword, thereby extracting entry words (names) that include the keyword (step A2). For example, when characters input to the keyword input area Ek are only the character “fish” and “blue” as shown by (B) in FIG. 7, items of information that include both of the characters, such as “Horse mackerel” and “Pacific saury,” are extracted.

Then, a list of entry words (names) (for example, “Horse mackerel” “Pacific saury” . . . ) extracted from the pictorial dictionary 22b4 is displayed by the main display module 16 (step A3). In this list of entry words (names), if an entry word (name) desired by the user (for example, “Horse mackerel”) has been selected (step A4), explanatory information composed of an image and a description of “Horse mackerel” stored so as to correspond to the selected entry word (name) “Horse mackerel” is read and displayed on the entire screen of the main display module 16 (step A5).

As a result, not only can the desired character be input directly to the keyword input area Ek by the operation of the character input keys 14a when [Compound retrieval] has been selected, but also directly specifying the position of the desired color on the color palette CP enables the specified color to be input in characters. Using each input character as a keyword, the entire text of the specified dictionary can be searched.

On the other hand, with the compound retrieval input screen Gf being displayed (steps S12, S13), when the user selects a color input area Ec with cursor H and specifies color input (Yes in step S21), the touch operation of the color palette CP is accepted and a color is input (step S22). Then, image data on a color corresponding to the color (RGB value) in the position specified by the touch operation is input to the color input area Ec and displayed (step S23). For example, when the color input area Ec is specified in the state of (A) in FIG. 7 and the position of blue on the color palette CP is specified, image data on blue recognized according to the RGB value of the specified position is input to the color input area Ec and displayed as shown by (C) in FIG. 7.

Here, when [Translate/Confirm] key 14c is operated to search a dictionary using the character “fish” input to the keyword input area Ek and blue input to the color input area Ec (Yes in step S17), control is passed to a compound retrieval process in FIG. 8 (step SA).

In the compound retrieval process, if it has been determined that the contents input on the compound retrieval input screen Gf are both the character “fish” input to the keyword input area Ek and the color “Blue” input to the color input area Ec (step A1 [No]→A6 [No]), the entire text of all the entry words (names) and explanatory information stored in the pictorial dictionary 22b4 (FIG. 3) is searched for entry words (names) (for example, “Horse mackerel,” “Flatfish,” “Pacific saury,” . . . ) that include the keyword character “fish” (step A7).

Next, entry words (names) retrieved using only the keyword character “fish” (“Horse mackerel,” “Flatfish,” “Pacific saury,” . . . ) are narrowed down on the basis of color information (HSV value) of the color “Blue” input to the color input area Ec (step A8).

Specifically, it is assumed that the RGB values of blue specified on the color palette CP are, for example, R=44, G=61, and B=143 and that HSV values obtained by a nonlinear conversion of those values are H=230°, S=69%, and V=56%. Then, if color information on “Horse mackerel” stored in the pictorial dictionary 22b4 is (HSV=241, 31, 57), color information on “Flatfish” is (HSV=349, 86, 40), and color information on “Pacific saury” is (HSV=243, 71, 54), the entry words will be narrowed down to “Horse mackerel” and “Pacific saury” in the vicinity (±5 to 10) of the HSV value of the blue.

Then, a list of the entry words (names) narrowed-down and retrieved, “Horse mackerel” “Pacific saury,” is displayed in an free area of the compound retrieval input screen Gf (step A3). In this list of entry words (names), if an entry word (name) desired by the user (for example, “Horse mackerel”) has been selected (step A4), explanatory information composed of an image and a description of “Horse mackerel” stored so as to correspond to the selected entry word (name) “Horse mackerel” is read and displayed on the entire screen of the main display module 16 (step A5).

As a result, not only is the pictorial dictionary 22b4 searched for the entire text of entry words (names) and explanatory information using the character input to the keyword input area Ek, but also dictionary information composed of names (entry words) and images/descriptions (explanatory information) can be retrieved easily and suitably by specifying a desired color on the color palette CP and retrieving color information corresponding to an image of each item of explanatory information on the basis of a color input to the color input area Ec.

On the other hand, on the compound retrieval input screen Gf of FIG. 6, when no character has been input to the keyword input area Ek and only a color specifying the position of a desired color on the color palette CP has been input to the color input area Ec (steps S12, S13, S21 to S23), it is determined in a compound retrieval process of FIG. 8 that the contents input on the compound retrieval input screen Gf are only colors (Yes in step A6).

Then, the RGB value of the color input to the color input area Ec is nonlinearly converted into an HSV value (step A9). Color information (HSV) caused to correspond to each entry word (name) and explanatory information (images and descriptions) stored in the pictorial dictionary 22b4 is searched for according to the HSV value (step A10).

Then, entry words (names) that have color information (HSV) retrieved according to the specified color are extracted and displayed in list form in a free area of the compound retrieval input screen Gf (step A3).

When an entry word (name) desired by the user has been selected from the list of entry words (names) (step A4), explanatory information composed of the images and descriptions stored so as to correspond to the selected entry word (name) is read and displayed on the entire screen of the main display module 16 (step A5).

As a result, even if the user does not know the name (entry word) of, for example, an animal or a plant for which the user is going to consult the pictorial dictionary 22b4, just specifying a main color of the animal or plant on the color palette CP to input the color to the color input area Ec enables only the entry words (names) of animals and plants of the color to be retrieved and displayed in list form and further enables explanatory information composed of the name (entry word), images, and descriptions of the desired animal or plant to be retrieved and displayed easily and suitably.

While in the embodiment, a desired color on the color palette CP has been specified and input to the color input area Ec of the compound retrieval input screen Gf, a plurality of colors may be specified and input. In this case, each of the colors input to the color input area Ec is converted into the HSV value of the color. Items of color information (HSV) caused to correspond to the individual entry words (names) and items of explanatory information (images and descriptions) stored in the pictorial dictionary 22b4 are OR-retrieved according to the HSV values of the individual colors.

Specifically, when the characters “fruit” have been input to the keyword input area Ek to perform retrieval and a list of retrieved entry words (names) has been displayed as, for example, “Mandarin orange,” “Green apple,” “Strawberry,” if two places on the color palette CP are specified to input two colors, green and red, to the color input area Ec and retrieval is performed, the orange “Mandarin orange” is removed and the contents of the list are narrowed down to “Green apple” and “Strawberry,” which are then displayed in list form.

The methods of the individual processes performed by the electronic dictionary device 10, including the pictorial book search process shown in the flowchart of FIG. 4 and the compound retrieval process in connection with the pictorial book search process shown in the flowchart of FIG. 8, and the dictionary database 22b including the pictorial dictionary 22b4 and others, written in the embodiment can be stored in the external storage medium 23, such as a memory card (for example, a ROM card or a RAM card), a magnetic disk (for example, a floppy disk or a hard disk), an optical disk (for example, a CD-ROM or a DVD), or a semiconductor memory, in the form of programs the computer can execute. Then, the media 23 can be delivered. The computer of an electronic device with a main screen 16 and an auxiliary screen 15 loads the program stored in the external storage medium 23 into a storage device 22. The computer is controlled by the read-in program, thereby realizing the function of easily retrieving dictionary data that has color information by directly specifying a color on the color palette CP explained in the embodiment, which enables the same processes in the aforementioned methods to be performed.

Furthermore, the data of the programs which realize the above methods can be transferred in the form of program code through a network N. The program data can be loaded by a communication control module 25 into the computer of an electronic device with a main screen 16 and a auxiliary screen 15 which is connected to the network N, thereby realizing the function of easily retrieving dictionary data that has color information by directly specifying a color on the color palette CP.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information retrieval device comprising:
a dictionary storage module which stores an entry word, explanatory information that includes an image corresponding to the entry word, and color information on the image so as to correlate the entry word, the explanatory information, and the color information with one another;
a color sample display module which display a color sample;
a color specify module which specifies an arbitrary color according to a user operation from the color sample displayed by the color sample display module;
a color retrieval module which retrieves explanatory information stored in the dictionary storage module so as to be correlated with color information corresponding to a color specified by the color specify module; and
a retrieved information output module which outputs explanatory information retrieved by the color retrieval module.

2. The information retrieval device of claim 1, further comprising:
a character conversion module which converts a color specified by the color specify module into a character representing the color when a search word is input in characters; and
a text retrieval module which retrieves explanatory information that includes characters converted by the character conversion module from the explanatory information stored in the dictionary storage module,
wherein the retrieved information output module outputs explanatory information that includes characters representing the specified color retrieved by the text retrieval module.

3. The information retrieval device of claim 2, wherein the color sample display module includes a module that displays an image that represents shades of multiple colors gradationally.

4. The information retrieval device of claim 3, further comprising:
a compound retrieval input accept module which not only accepts, as a keyword, a character input according to a user operation or a character converted by the character conversion module, but also accepts, as a search color, a color specified by the color specify module; and
a compound retrieval module which causes the text retrieval module and the color retrieval module to perform retrieval according to the keyword or search color accepted by the compound retrieval input accept module,
wherein the retrieved information output module outputs explanatory information retrieved by the compound retrieval module.

5. The information retrieval device of claim 4, further comprising:
an entry word input accept module which accepts the input of a character for the retrieval of an entry word; and
an entry word retrieval module which retrieves an entry word based on the input character accepted by the entry word input accept module,
wherein the retrieved information output module outputs explanatory information retrieved by the entry word retrieval module.

6. The information retrieval device of claim 5, further comprising:
a main screen and a auxiliary screen,
wherein the color sample display module displays a color sample of multiple colors on the auxiliary screen, and
the retrieved information output module displays retrieved information on the main screen.

7. An information retrieval method in an information retrieval device which includes a memory that stores an entry word, explanatory information including an image corresponding to the entry word, and color information on the image so as to correlate the entry word, the explanatory information, and the color information with one another, the information retrieval method comprising:
displaying a color sample;
prompting the user to specify an arbitrary color from the displayed color sample;
retrieving explanatory information stored in the memory so as to be correlated with color information corresponding to a color specified by the user; and
outputting the retrieved explanatory information.

8. The information retrieval method of claim 7, further comprising:
converting a color specified according to the displayed color sample into a character representing the color when a search word is input in characters; and
retrieving explanatory information that includes the converted character from the explanatory information stored in the memory, and
outputting retrieved explanatory information that includes a character representing the specified color.

9. The information retrieval method of claim 8, wherein the displaying a color sample includes displaying an image that represents shades of multiple colors gradationally.

10. The information retrieval method of claim 9, further comprising:
accepting, as a keyword in retrieval data for compound retrieval, a character input according to a user operation or a character obtained by converting a color specified from the displayed color sample;
accepting a color specified from the color sample as a search color in retrieval data for compound retrieval;
performing compound retrieval, including text retrieval and color retrieval, according to the accepted keyword and search color; and
outputting explanatory information obtained by the compound retrieval.

11. The information retrieval method of claim 10, further comprising:
accepting the input of a character for the retrieval of an entry word; and
retrieving an entry word based on the accepted input character; and
outputting explanatory information retrieved based on an entry word.

12. The information retrieval method of claim 11, wherein the information retrieval device includes a main screen and a auxiliary screen,
the displaying a color sample includes displaying a color sample of multiple colors on the auxiliary screen, and
the retrieved explanatory information is displayed on the main screen.

13. An electronic device comprising a display device, a memory, and a processor, the memory storing an entry word, explanatory information including an image corresponding to the entry word, and color information on the image so as to correlate the entry word, the explanatory information, and the color information with one another, and the processor executing a program stored in the memory to be caused to:
display a color sample;
prompt the user to specify an arbitrary color from the displayed color sample;
retrieve explanatory information stored in the memory so as to be correlated with color information corresponding to a color specified by the user; and
output the retrieved explanatory information.

14. The electronic device of claim 13, wherein the processor is further caused to:
convert a color specified according to the displayed color sample into a character representing the color when a search word is input in characters;
retrieve explanatory information that includes the converted character from the explanatory information stored in the memory; and
output explanatory information that includes a character representing the specified color retrieved.

15. The electronic device of claim 14, wherein the processor is further caused to:
display an image that represents shades of multiple colors gradationally in displaying the color sample.

16. The electronic device of claim 15, wherein the processor is further caused to:
accept, as a keyword in retrieval data for compound retrieval, a character input according to a user operation or a character obtained by converting a color specified from the displayed color sample;
accept a color specified from the color sample as a search color in retrieval data for compound retrieval;
perform compound retrieval, including text retrieval and color retrieval, according to the accepted keyword and search color; and
output explanatory information obtained by the compound retrieval.

17. The electronic device of claim 16, wherein the processor is further caused to:
accept the input of a character for the retrieval of an entry word; and
retrieve an entry word based on the accepted input character; and
output explanatory information retrieved based on an entry word.

18. The electronic device of claim 17, wherein the display device includes a main screen and a auxiliary screen, and
the processor is further caused to:
display a color sample of multiple colors on the auxiliary screen in displaying the color sample; and
display the retrieved explanatory information on the main screen.
